(19) United States
(12) Patent Application Publication
(10) Pub. No.: US 2009/0063051 A1
(43) Pub. Date: Mar. 5, 2009

(54) Method And Apparatus Of Updating Vehicle Position And Orientation

(76) Inventors: Takayuki Watanabe, Iwaki-city (JP); Takayuki Hoshizaki, Torrance, CA (US); Kotaro Wakamatsu, Iwaki-city (JP); Takehiko Sakagami, Iwaki-city (JP)

Correspondence Address: ALPINE/BHGL, P.O. Box 10395, Chicago, IL, 60610, US

(21) Appl. No.: 12/190,374

(22) Filed: Aug. 12, 2008

(30) Foreign Application Priority Data
Aug. 30, 2007 (JP) 2007-223405

(51) Int. Cl. G01C 21/28

(52) U.S. Cl. 701/216

(57) ABSTRACT

A method of updating the position and orientation of a vehicle at startup of a navigation system using both a GPS receiver and a dead reckoning sensor includes the acts of storing the vehicle position and orientation when the navigation system is inoperative and setting the stored vehicle position and orientation as the initial vehicle position and orientation when the navigation system is operative; estimating a vehicle position and orientation by using a signal output from the dead reckoning sensor and the initial vehicle position and orientation after the navigation system becomes operative; determining whether the reliability of a GPS orientation obtained by the GPS receiver becomes sufficiently high after the navigation system becomes operative; and updating the current vehicle position by using the GPS orientation and the estimated vehicle position when the reliability of the GPS orientation obtained by the GPS receiver becomes sufficiently high.

### RELATED APPLICATION

The present application claims priority to Japanese Patent Application Number 2007-223405, filed Aug. 30, 2007, the entirety of which is hereby incorporated by reference.

### BACKGROUND OF THE INVENTION

1. Field of the Invention

The present invention relates to methods and apparatuses for updating vehicle positions and orientations. More particularly, the present invention relates to a method and apparatus for updating a vehicle position and orientation during navigation and traveling in a navigation system using both a Global Positioning System (GPS) receiver and a dead reckoning sensor.

2. Description of the Related Art

Navigation systems read out map data corresponding to the current position of a vehicle from a map data storage unit, such as a digital versatile disk (DVD) or a hard disk (HDD), and display the map data for a map on a display screen. In addition, the navigation systems move a mark indicating the vehicle position (vehicle position mark) on the map in accordance with the travel of the vehicle or display the vehicle position mark at a fixed position (for example, the central position) on the display screen and scroll the map.

It is essential for the navigation system to measure the current position of the vehicle. Accordingly, dead reckoning navigation, satellite navigation, and methods using both the dead reckoning navigation and the satellite navigation are put into practical use in the related art. Dead reckoning navigation is a measurement method in which a distance sensor and a dead reckoning sensor, such as an orientation sensor (gyroscope), which are mounted in a vehicle are used to measure the vehicle position. Satellite navigation is a measurement method adopting a Global Positioning System (GPS) using satellites.

Each navigation system is provided with, for example, a function of updating the vehicle position by map matching, a route guidance function of searching for a guide route to a destination and displaying the guide route on a map, and an intersection guidance function. Map matching is a function of updating the vehicle position to a position on the road link if the error in the vehicle position estimated by using signals output from the dead reckoning sensor increases and the vehicle position goes off the road. When the vehicle position cannot be updated to a position on the road link by map matching because the error in the vehicle position becomes too large, positional data measured by the GPS is adopted as the vehicle position that is updated to a position on the road link by map matching.

In dead reckoning navigation, the vehicle position is estimated in the following manner on the basis of outputs from the distance sensor and the relative orientation sensor. FIG. 14 illustrates a method of estimating a vehicle position by dead reckoning navigation. Referring to FIG. 14, it is assumed that the distance sensor outputs a pulse each time the vehicle travels a unit distance L₀ (for example, 10 m), and that the reference orientation (θ=0) is the positive direction along the X axis and counterclockwise rotation with respect to the reference orientation is positive rotation. A variation in the vehicle position can be calculated according to Equations (1) and (2):

ΔX=L₀·cos(θ₀+Δθ₁) (1)

ΔY=L₀·sin(θ₀+Δθ₁) (2)

where a point P₀ (X₀,Y₀) denotes the previous vehicle position, θ₀ denotes the absolute orientation of the vehicle traveling direction at the point P₀, and Δθ₁ denotes an output from the relative orientation sensor at a point when the vehicle travels the unit distance L₀.

An estimated orientation θ₁ of the vehicle traveling direction and an estimated vehicle position (X₁,Y₁) at a current point P₁ can be calculated according to Equations (3) to (5) by vector synthesis.

θ₁=θ₀+Δθ₁ (3)

X₁=X₀+ΔX=X₀+L₀·cos θ₁ (4)

Y₁=Y₀+ΔY=Y₀+L₀·sin θ₁ (5)

Accordingly, with the absolute orientation and the positional coordinate of the vehicle at the start point measured by the GPS, the calculation according to Equations (3) to (5) can be repeated each time the vehicle travels the unit distance to detect (estimate) the vehicle position in real time.

However, in dead reckoning navigation, errors are accumulated as the vehicle travels and the estimated vehicle position goes off the road. In such a case, the estimated vehicle position is checked against the road data by the map matching process to update the estimated vehicle position to the actual vehicle position on the road.

FIG. 15 illustrates the map matching process using a projection method. Referring to FIG. 15, it is assumed that a point P′ᵢ (Xᵢ′,Yᵢ′) denotes the current vehicle position and θᵢ₋₁ denotes the vehicle orientation (the point Pᵢ₋₁ is not on the road RDa in the example in FIG. 15). An estimated vehicle position Pᵢ₋₁ (Xᵢ′,Yᵢ′) by dead reckoning navigation and an estimated vehicle orientation θᵢ at the estimated vehicle position Pᵢ′ can be calculated according to Equations (6) to (8):

θᵢ=θᵢ₋₁+Δθᵢ (6)

Xᵢ′=Xᵢ₋₁+L₀·cos θᵢ (7)

Yᵢ′=Yᵢ₋₁+L₀·sin θᵢ (8)

where Δθᵢ denotes the relative orientation when the vehicle travels a predetermined distance L₀ (for example, 10 m) from the point Pᵢ₋₁.

Map matching using the projection method is performed in the following manner.

(a) Any link (an element composing a road) which is within a range of 200 m around the estimated vehicle position Pᵢ′ and to which a perpendicular can be drawn is found. The angle between the link and the estimated vehicle orientation θᵢ at the estimated vehicle position Pi′ must be not larger than a predetermined value (for example, 45°) and the length of the perpendicular line drawn from the estimated vehicle position Pi′ to the link must be not longer than a predetermined value (for example, 100 m). In the example shown in FIG. 15, a link LKa₁ (a straight line between nodes Na₀ and Na₁) having an orientation θa₁ on the road RDa and a link LKb₁ (a straight line between nodes Nb₀ and Nb₁) having an orientation θb₁ on the road RDb are found.

(b) The lengths of perpendicular lines RLia and RLib drawn from the estimated vehicle position Pi′ to the links LKa₁ and LKb₁, respectively, are calculated.

(c) A factor Z is calculated according to Equation (9) or (10):

Z=dL·20+dθ·20(dθ≦25°) (9)

Z=dL·20+dθ·40(dθ>25°) (10)

where dL denotes the length of the perpendicular line drawn from the estimated vehicle position Pi′ to the link (the distance between the estimated vehicle position and the link) and dθ denotes the angle between the estimated vehicle orientation θᵢ and the link. The weighting factor is increased with the increased angle dθ.

(d) After the factor Z is determined, a link satisfying the following conditions (1) to (3) is found.

(1) the distance dL≦75 m (maximum attractive distance 75 m)

(2) the difference in angle dθ≦30° (maximum attractive angle 30°)

(3) the factor Z≦1500

The link having the minimum factor is set as a matching candidate (optimal road). In the example shown in FIG. 15, the link LKa₁ is set as a matching candidate.

(e) A travel trajectory SHᵢ between the point Pᵢ₋₁ and the estimated vehicle position Pi′ is subjected to parallel translation in the direction of the perpendicular line RLia until the point Pᵢ₋₁ is on the link LKa₁ (or on am extension of the link LKa₁) to determine points PTᵢ₋₁ and PTᵢ′ after translation from the points Pᵢ₋₁ and Pᵢ′, respectively.

(f) The point PTᵢ′ is subjected to rotational translation around the point PTᵢ₋₁ until the point PTᵢ′ is on the link LKa₁ (or on an extension of the link LKa₁) to determine the point after rotational translation, and the point after the rotational translation is set as an actual vehicle position Pᵢ(Xᵢ,Yᵢ). If any link satisfying the above conditions does not exist, it is considered that map matching is unsuccessful.

The vehicle position can go off the road by mismatching or can be on a wrong road because the errors are accumulated and the map matching is unsuccessful. In such a case, the vehicle position and orientation are updated by using GPS data (GPS positional data and GPS orientation data) acquired by a GPS receiver. Then, the vehicle position and orientation are updated to a position and orientation on the road by map matching, and dead reckoning navigation is continued.

The update of the vehicle position and orientation by using GPS data in the related art is performed when the reliabilities (accuracies) of both the GPS position and the GPS orientation are increased. Since it is unlikely to concurrently increase the reliabilities of both the GPS position and the GPS orientation when the GPS reception environment is not good, for example, when the vehicle is surrounded by buildings, the vehicle position and orientation are not immediately updated even when map matching is unsuccessful to cause the mismatching and, therefore, the time when the vehicle position returns to the correct position can be delayed. Such a problem may occur in the following cases.

(1) First Case

The above problem can occur in a first case in which the navigation system mounted in a vehicle is turned off when the vehicle gets on a turntable in a building, the navigation system is made operative again after the turn of the turntable, and the vehicle leaves the building. The vehicle position and orientation when the navigation system is turned off (when the control of the navigation system is stopped) are used as the initial position and orientation of vehicle when the navigation system becomes operative next time. Accordingly, if the orientation of the vehicle is changed due to the rotation of the turntable, the vehicle orientation when the navigation system becomes operative again is shifted from the actual orientation, and mismatching occurs after the vehicle leaves the building. FIG. 16 illustrates such a situation. In the example in FIG. 16, “PBL” denotes a multi-level parking garage, “TBL” denotes a turntable in the multi-level parking garage, and “RD” denotes a road. Assuming that the vehicle is turned by the turntable TBL by 180° from a vehicle orientation θs when the navigation system is turned off, the actual vehicle orientation is shifted from the initial orientation θs by 180° when the navigation system becomes operative again. Accordingly, when the vehicle starts to travel along a dotted line and the dead reckoning sensor is used to estimate the vehicle position and orientation, the trajectory DRT of the estimated vehicle position (dead reckoning navigation trajectory DRT), which is denoted by a solid line, is shifted from the actual travel trajectory ART and mismatching occurs after the vehicle leaves the building.

(2) Second Case

The above problem can occur in a second case in which the navigation system mounted in a vehicle is made operative in a multi-level parking garage that is not capable of GPS reception, and the vehicle repeats circular movement while ascending or descending the slope in the multi-level parking garage to leave the parking garage. Since the vehicle performs the circular movement while tilting toward one side in the multi-level parking garage, the difference in the gyro sensitivity is increased and the vehicle orientation is gradually shifted. As a result, the actual vehicle orientation is greatly shifted from the estimated orientation when the vehicle leaves the multi-level parking garage to cause mismatching after the vehicle leaves the multi-level parking garage.

In the first and second cases described above, the update of the vehicle position and orientation by using GPS data after the vehicle leaves the multi-level parking garage is performed when the reliabilities (accuracies) of both the GPS position and the GPS orientation are increased. Accordingly, the time when the vehicle position returns to the correct position is delayed in the unfavorable GPS reception environment. In general, the accuracy of the GPS position is worse than that of the GPS orientation when the GPS reception environment is not good.

Japanese Unexamined Patent Application Publication No. 2002-148063 discloses a technology for correcting the error in the current position and traveling direction of a vehicle as rapidly as possible. The difference is caused by, for example, use of a parking garage. In this technology, the vehicle position and orientation are estimated by dead reckoning navigation on the basis of the reference position and, (1) when the angle between the vector connecting the reference position to the GPS position and the vector connecting the reference position to the position estimated by dead reckoning navigation exceeds a predetermined value after the GPS reception becomes enabled or (2) when the difference between the distance between the reference position and the GPS position and the distance between the reference position and the position estimated by dead reckoning navigation exceeds a predetermined value after the GPS reception becomes enabled, the GPS positional data and the GPS orientation data are adopted as the current vehicle position and orientation.

However, in the above related art in which the GPS positional data and GPS orientation data are adopted as the current vehicle position and orientation when the angle or the difference in distance exceeds a predetermined value, there is a problem in that the reliability of the GPS position and orientation is uncertain and, therefore, the position and orientation cannot be correctly updated. In addition, there is another problem in that the angle or the difference in distance does not exceed a predetermined value even when the reliability of the GPS position and orientation becomes sufficiently high and, therefore, the update of the position and orientation may be delayed.

### SUMMARY OF THE INVENTION

Accordingly, it is an object of the present invention to update the position and orientation of a vehicle on the basis of GPS orientation when the GPS reception becomes enabled.

It is another object of the present invention to update the position and orientation of a vehicle to the correct position and orientation within a short time after the GPS reception becomes enabled.

According to an embodiment of the present invention, a method of updating the position and orientation of a vehicle at startup of a navigation system using both a GPS receiver and a dead reckoning sensor includes the acts of storing the vehicle position and orientation when the navigation system is inoperative and setting the stored vehicle position and orientation as the initial vehicle position and orientation when the navigation system is operative; estimating a vehicle position and orientation by using a signal output from the dead reckoning sensor and the initial vehicle position and orientation after the navigation system becomes operative; determining whether the reliability of a GPS orientation obtained by the GPS receiver becomes sufficiently high after the navigation system becomes operative; and updating the current vehicle position by using the GPS orientation and the estimated vehicle position when the reliability of the GPS orientation obtained by the GPS receiver becomes sufficiently high. The updating step may calculate a difference Δθ between the GPS orientation and the estimated vehicle orientation and sets the vehicle position obtained by rotating the estimated vehicle position around the initial vehicle position by the difference Δθ as the current vehicle position. Alternatively, the updating step may calculate a distance between the initial vehicle position and the estimated vehicle position and sets the position apart from the initial vehicle position in the direction of the GPS orientation by the calculated distance as the current vehicle position.

According to another embodiment of the present invention, a method of updating the position and orientation of a vehicle at startup of a navigation system using both a GPS receiver and a dead reckoning sensor includes the acts of storing the vehicle position and orientation at a time when entrance of the vehicle into a multi-level parking garage is detected; estimating a current vehicle position and orientation by using a signal output from the dead reckoning sensor and the stored vehicle position and orientation after the entrance of the vehicle into the multi-level parking garage is detected; determining whether the reliability of a GPS orientation obtained by the GPS receiver becomes sufficiently high after the entrance of the vehicle into the multi-level parking garage is detected; and updating the current vehicle position by using the GPS orientation and the estimated vehicle position when the reliability of the GPS orientation obtained by the GPS receiver becomes sufficiently high.

According to another embodiment of the present invention, an apparatus for updating the position and orientation of a vehicle at startup of a navigation system using both a GPS receiver and a dead reckoning sensor includes a storage unit that stores the vehicle position and orientation when the navigation system is inoperative as the initial vehicle position and orientation when the navigation system is operative; a position-and-orientation estimating unit that estimates a vehicle position and orientation by using a signal output from the dead reckoning sensor and the initial vehicle position and orientation after the navigation system becomes operative; a GPS orientation reliability determining unit that determines whether the reliability of a GPS orientation obtained by the GPS receiver becomes sufficiently high after the navigation system becomes operative; and an updating unit that updates the current vehicle position by using the GPS orientation and the estimated vehicle position when the reliability of the GPS orientation obtained by the GPS receiver becomes sufficiently high.

The updating unit may include calculating means for calculating a difference Δθ between the GPS orientation and the estimated vehicle orientation and updating means for updating the current vehicle position by rotating the estimated vehicle position around the initial vehicle position by the difference Δθ. Alternatively, the updating unit may include calculating means for calculating a distance between the initial vehicle position and the estimated vehicle position and means for setting the position apart from the initial vehicle position in the direction of the GPS orientation by the calculated distance as the current vehicle position.

According to another embodiment of the present invention, an apparatus for updating the position and orientation of a vehicle at startup of a navigation system using both a GPS receiver and a dead reckoning sensor includes a detecting unit that detects entry of the vehicle into a multi-level parking garage; a storage unit that stores the vehicle position and orientation when the entry of the vehicle into the multi-level parking garage is detected; a position-and-orientation estimating unit that estimates a current vehicle position and orientation by using a signal output from the dead reckoning sensor and the stored vehicle position and orientation after the entry of the vehicle into the multi-level parking garage is detected; a GPS orientation reliability determining unit that determines whether the reliability of a GPS orientation obtained by the GPS receiver becomes sufficiently high after the entry of the vehicle into the multi-level parking garage is detected; and an updating unit that updates the current vehicle position by using the GPS orientation and the estimated vehicle position when the reliability of the GPS orientation obtained by the GPS receiver becomes sufficiently high.

According to the present invention, since the current vehicle position is updated by using the GPS orientation and the estimated orientation when the reliability of the GPS orientation becomes sufficiently high, it is possible to update the vehicle position and orientation to the correct position and orientation within a short time when the GPS reception becomes enabled.

According to the present invention, it is possible to update the vehicle position and orientation to the correct position and orientation within a short time even when the vehicle is parked in a multi-level parking garage that is not capable of the GPS reception, the navigation system is turned off, and the vehicle leaves the multi-level parking garage with the navigation system operative.

According to the present invention, it is possible to update the vehicle position and orientation to the correct position and orientation within a short time even when the navigation system is turned off and the vehicle starts to travel after the rotation of the turntable.

According to the present invention, it is possible to update the vehicle position and orientation to the correct position and orientation within a short time even when the vehicle leaves the multi-level parking garage without stopping in the multi-level parking garage.

### BRIEF DESCRIPTION OF THE DRAWINGS

FIG. 1 illustrates a situation in which the navigation system mounted in a vehicle is turned off when the vehicle gets on a turntable in a building such as a multi-level parking garage, the navigation system is made operative again after the rotation of the turntable, and the vehicle leaves the building;

FIGS. 2A and 2B illustrate examples to which an embodiment of the present invention is applied in the situation shown in FIG. 1;

FIG. 3 is a block diagram showing an example of the configuration of a navigation system including a vehicle position-and-orientation updating section according to a first embodiment of the present invention;

FIG. 4 is a block diagram showing in detail an example of the configuration of the vehicle position-and-orientation updating section;

FIG. 5 is a flowchart showing an example of a determination process in which a GPS reliability determiner determines whether the reliability of a GPS orientation is high;

FIG. 6 is a flowchart schematically showing an example of an update process in the vehicle position-and-orientation updating section when the navigation system is made operative;

FIG. 7 is a flowchart showing an example of a position and orientation update step;

FIG. 8 is a flowchart showing another example of the position and orientation update step;

FIG. 9 illustrates a first exemplary advantage of the present invention;

FIG. 10 illustrates a second exemplary advantage of the present invention;

FIG. 11 is a block diagram showing an example of the configuration of a vehicle position-and-orientation updating section according to a second embodiment of the present invention;

FIG. 12 is a flowchart showing an example of an update process in the vehicle position-and-orientation updating section according to the second embodiment of the present invention;

FIG. 13 is a block diagram showing an example of the configuration of a vehicle position-and-orientation updating section according to an exemplary modification;

FIG. 14 illustrates a method of estimating a vehicle position by dead reckoning navigation;

FIG. 15 illustrates map matching using a projection method; and

FIG. 16 illustrates a situation in which a vehicle orientation when a navigation system is made operative is shifted from the actual orientation and mismatching occurs after the vehicle leaves a building.

### DESCRIPTION OF THE PREFERRED EMBODIMENTS

### First Embodiment

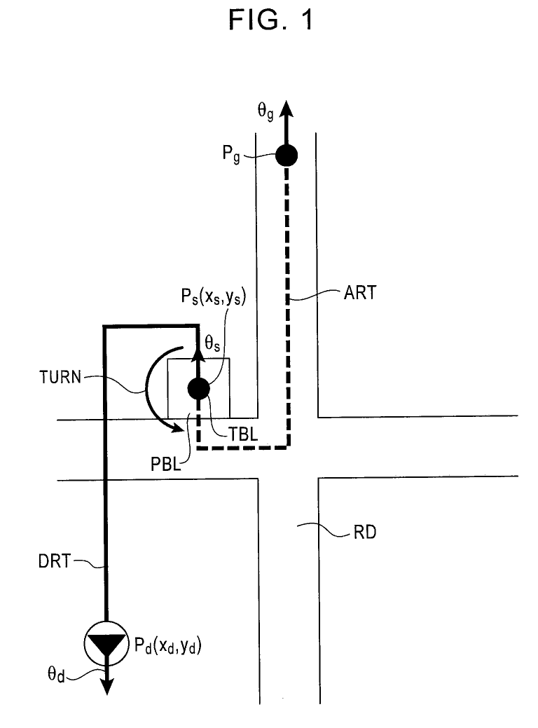

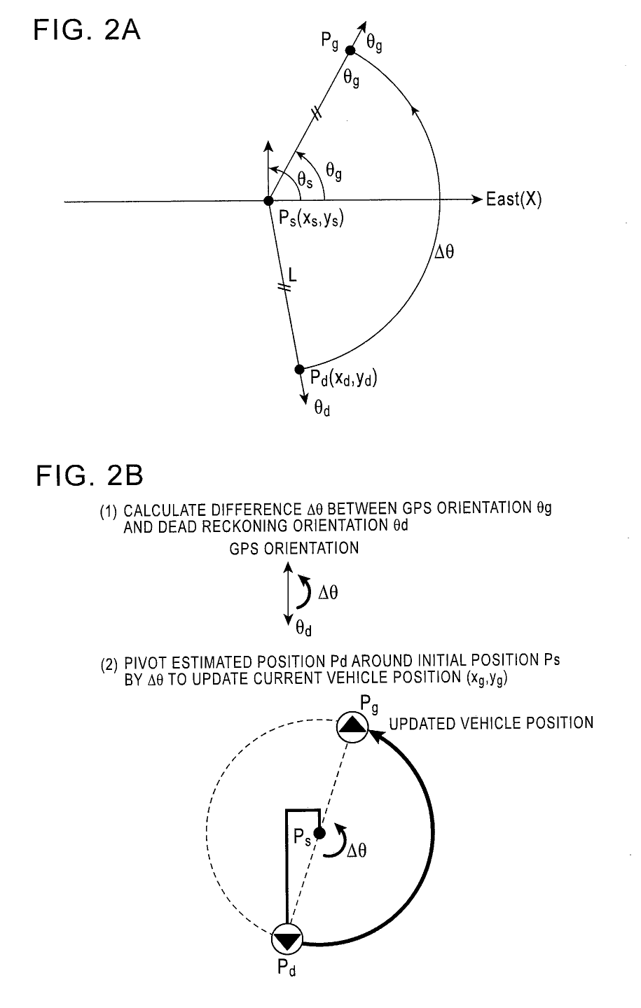

FIG. 1 illustrates a situation in which the navigation system mounted in a vehicle is turned off when the vehicle gets on a turntable in a building such as a multi-level parking garage, the navigation system is made operative again after the rotation of the turntable, and the vehicle leaves the building. FIGS. 2A and 2B illustrate examples to which an embodiment of the present invention is applied in the situation shown in FIG. 1. Referring to FIG. 1, “PBL” denotes a multi-level parking garage, “TBL” denotes a turntable in the multi-level parking garage, and “RD” denotes a road.

It is assumed that the navigation system is turned off after the vehicle gets on the turntable, the vehicle is rotated by the turntable TBL by a predetermined angle, for example, by 180°, and the vehicle starts to travel with the navigation system operative. In the example in FIG. 1, the vehicle orientation and the vehicle position after the navigation system is turned off are denoted by θₛ and Pₛ(xₛ,yₛ), respectively, and the navigation system estimates the vehicle position and orientation by dead reckoning navigation after the navigation system becomes operative again.

The vehicle orientation θₛ stored in the navigation system is shifted from the actual vehicle orientation by 180° due to the rotation of the turntable when the navigation system becomes operative. Accordingly, when the vehicle starts to travel along a path indicated by the dotted line, a dead reckoning navigation trajectory DRT indicated by a solid line is oriented in a direction opposite to that of an actual travel trajectory ART indicated by the dotted line.

According to the embodiment of the present invention, the reliability of the GPS orientation is monitored. If the reliability of a GPS orientation θ_{g} is sufficiently high when the vehicle reaches a point P_{g}, the GPS orientation is set as the current orientation and the current vehicle position is updated by using the GPS orientation, an estimated position P_{d}(x_{d},y_{d}) estimated by the dead reckoning navigation, and an estimated orientation θ_{d}. Since the travel distance from the initial position Pₛ(x₅,yₛ) to the estimated position P_{d}(x_{d},y_{d}) where the reliability of the GPS orientation becomes high is short, the relative estimated position and orientation have higher reliability with respect to the initial position and, therefore, the current vehicle position updated by using the estimated position and orientation is correct. Even if the updated position goes off the road, it is possible to update the position to a position on the road by the map matching performed later.

In the example shown in FIG. 2A, the coordinate (x_{d},y_{d}) of the estimated position P_{d}, the estimated orientation θ_{d}, and the orientation θ_{g} at the current vehicle position P_{g} are known and a difference Δθ between the GPS orientation θ_{g} and the estimated orientation θ_{d} is calculated. Then, the estimated position P_{d}(x_{d},y_{d}) is pivoted around the initial position Pₛ (xₛ,yₛ) by the difference Δθ to calculate the coordinate (x_{g},y_{g}) of the current vehicle position point P_{g}. Specifically, as shown in FIG. 2B, (1) the difference Δθ between the GPS orientation θ_{g} and the estimated orientation θ_{d} is calculated, and (2) the estimated position P_{d}(x_{d},y_{d}) is pivoted around the initial position Pₛ(xₛ,yₛ) by the difference Δθ to calculate the coordinate (x_{g},y_{g}) of the current vehicle position point P_{g}.

### Navigation System

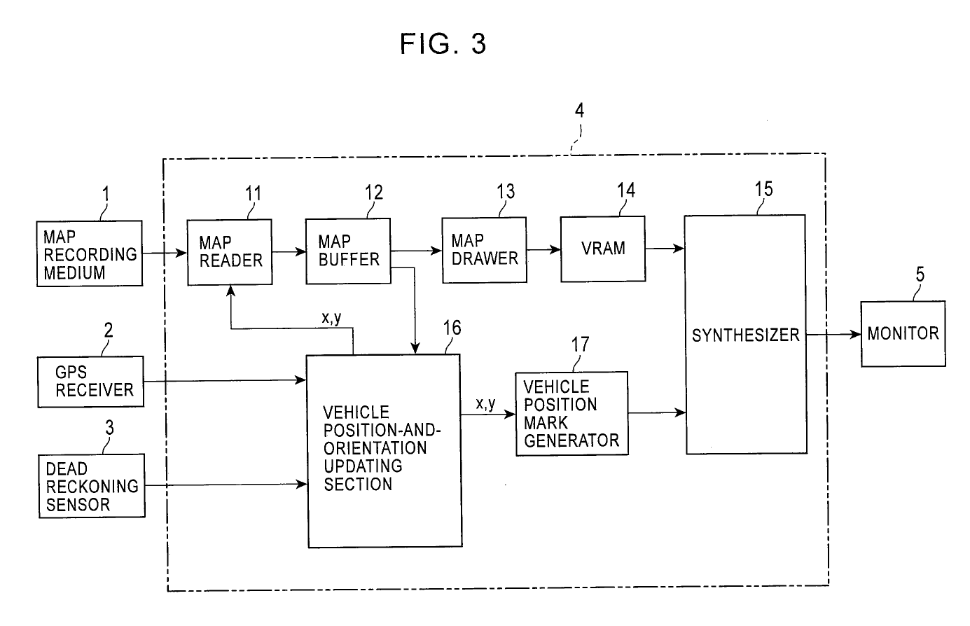

FIG. 3 is a block diagram showing an example of the configuration of a navigation system according to a first embodiment of the present invention. The navigation system in FIG. 3 is provided with a vehicle position-and-orientation updating section. Referring to FIG. 3, map data is recorded in a map recording medium 1 (for example, a compact disc-read only memory (CD-ROM), DVD, or HDD) and is read out as required. A GPS receiver 2 receives a GPS radio wave transmitted from a GPS satellite, measures the GPS position and GPS orientation of a vehicle every second on the basis of the received signal, and supplies the measured GPS position and GPS orientation to a navigation controlling unit 4. A dead reckoning sensor 3 includes an angular sensor, such as a gyroscope, detecting the rotation angle of the vehicle and a travel distance sensor generating a pulse for every predetermined travel distance. The dead reckoning sensor 3 supplies signals detected by the sensors to the navigation controlling unit 4. The navigation controlling unit 4 performs control of the calculation and update of the position and orientation of the vehicle, control of the generation of map images of the area around the vehicle, control of route search/route guidance, control of intersection guidance, and so on. A monitor 5 displays a map of the area around the vehicle, a guide route, a vehicle position mark, other guidance information, and menus in accordance with instructions supplied from the navigation controlling unit 4.

In the navigation controlling unit 4, a map reader 11 reads out map data of the area around the vehicle from the map recording medium 1 and stores the read map data in a map buffer 12. The map buffer 12 holds at least nine map areas including a map area corresponding to the vehicle position and map areas surrounding the vehicle and scrolls the map in accordance with the travel of the vehicle. A map drawer 13 generates a map image of the area around the vehicle by using the map data stored in the map buffer 12 and stores the generated map image in a video random access memory (VRAM) 14. A synthesizer 15 synthesizes the map image read out from the VRAM 14 with the vehicle position mark and/or the guide route image and displays the synthesized image on the monitor 5.

A vehicle position-and-orientation updating section 16 performs, for example, control of the estimation of the current vehicle position and orientation (vehicle position tracking control), map matching control, and the position update control described below. A vehicle position mark generator 17 generates a vehicle position mark at the vehicle position on the map and supplies the generated vehicle position mark to the synthesizer 15. The navigation controlling unit 4 further includes a route search-display controller that searches for a route to a destination and displays the route and a guidance controller that controls the intersection guidance, which are not shown in FIG. 3.

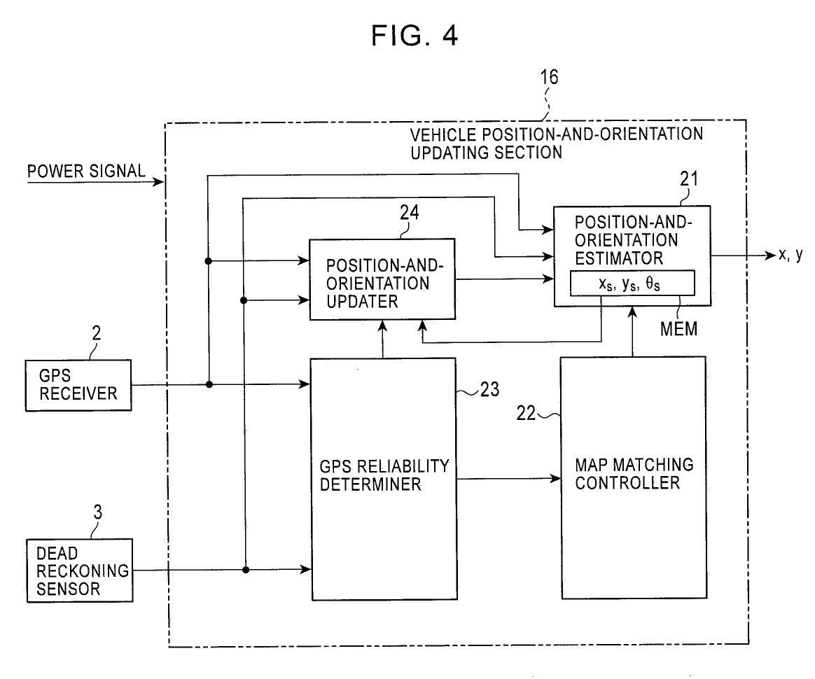

FIG. 4 is a block diagram showing in detail an example of the configuration of the vehicle position-and-orientation updating section 16. Referring to FIG. 4, a position-and-orientation estimator 21 adopts a GPS position at startup as the vehicle position, subsequently estimates the estimated position P_{d}(x_{d},y_{d}) and orientation θ_{d} of the vehicle by using signals output from the dead reckoning sensor 3, and supplies the coordinate (x_{d},y_{d}) of the estimated position to the map reader 11 and the vehicle position mark generator 17 as the coordinate (x,y) of the current vehicle position. When the navigation system is turned off after the vehicle is stopped, the position-and-orientation estimator 21 stores the vehicle position and orientation at the time when the vehicle is stopped as the initial position Pₛ(xₛ,yₛ) and the initial orientation θₛ at the time when the navigation system becomes operative in a memory MEM. A map matching controller 22 performs the map matching process to update the vehicle position (x,y) estimated by the position-and-orientation estimator 21 to a position on the road link. When the errors in the vehicle position estimated by the position-and-orientation estimator 21 are accumulated and the update by the map matching is disabled, the map matching controller 22 causes the position-and-orientation estimator 21 to adopt the GPS position as the current vehicle position and to subsequently continue the estimation of the vehicle position by using the signals output from the dead reckoning sensor 3. A GPS reliability determiner 23 determines whether the reliability of the GPS orientation calculated by using a GPS signal received by the GPS receiver 2 is high and supplies the determination result to the map matching controller 22 and a position-and-orientation updater 24. The position-and-orientation updater 24 updates the current vehicle position and orientation when the GPS orientation becomes stable, for example, when the navigation system becomes operative or when the vehicle leaves a multi-level parking garage.

### Determination of Reliability of GPS Orientation

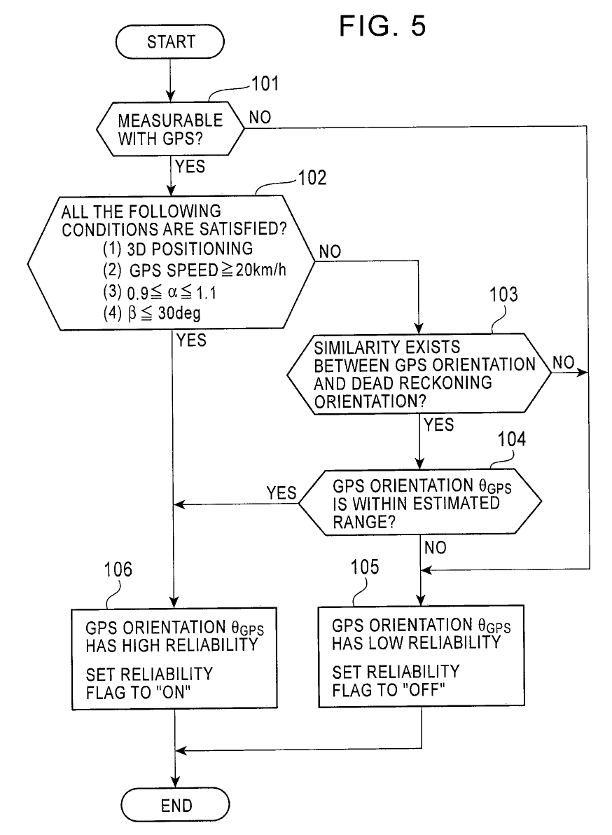

FIG. 5 is a flowchart showing an example of a determination process in which the GPS reliability determiner 23 determines whether the reliability of the GPS orientation is high. Referring to FIG. 5, in Step 101, the GPS reliability determiner 23 determines whether the GPS positioning is enabled. If the GPS positioning is disabled, then in Step 105, the GPS reliability determiner 23 determines that a GPS orientation θ_{GPS} has a low reliability and sets a reliability flag to “OFF”. If the GPS positioning is enabled, then in Step 102, the GPS reliability determiner 23 determines whether the following positioning conditions (1) to (4) are satisfied.

(1) Three-dimensional positioning (3D positioning). The three-dimensional positioning has a higher accuracy than two-dimensional positioning.
(2) GPS speed is higher than a threshold value (for example, 10 km/h). Since the orientation is calculated on the basis of Doppler shift, the accuracy of the GPS orientation is reduced if the GPS speed is low.
(3) Travel distance ratio α is within a predetermined range (for example, 0.9≦travel distance ratio ≦1.1). The travel distance ratio is a ratio between the travel distance calculated with the GPS position and the travel distance calculated with the vehicle speed pulse. The accuracy of the GPS positioning data is greater as the travel distance ratio approaches one.
(4) The difference in travel angle is not greater than a predetermined value (for example, the difference in travel angle ≧30°). The difference in travel angle means the difference between the angle between two GPS positions and the GPS orientation. The accuracy of the GPS positioning data is greater as the difference in travel angle approaches zero.
If all of the above positioning conditions are satisfied, then in Step 106, the GPS reliability determiner 23 determines that the GPS orientation θ_{GPS} has a high reliability and sets the reliability flag to “ON”.

If any of the above positioning conditions is not satisfied, then in Step 103, the GPS reliability determiner 23 determines whether similarity exists between the GPS orientation θ_{GPS} and an estimated orientation θ_{gyro} calculated by dead reckoning navigation. Specifically, the GPS reliability determiner 23 determines the similarity between the GPS orientation θ_{GPS} and the estimated orientation θ_{gyro} according to Equation (11):

Δθ=|(θ_{GPS1}−θ_{GPS2})−θ_{gyro}|≦10° (11)

where θ_{GPS1} denotes the current GPS orientation, θ_{GPS2} denotes the previous GPS orientation, and θ_{gyro} denotes the estimated orientation. If the Δθ is larger than 10°, the GPS reliability determiner 23 determines that no similarity exists between the GPS orientation θ_{GPS} and the estimated orientation θ_{gyro} In Step 105, the GPS reliability determiner 23 determines that the GPS orientation θ_{GPS} has a low reliability and sets the reliability flag to “OFF”.

If the Δθ is smaller than or equal to 10°, then in Step 104, the GPS reliability determiner 23 determines whether the current GPS orientation θ_{GPS1} is within an estimated range. If the current GPS orientation θ_{GPS1} is not within the estimated range, then in Step 105, the GPS reliability determiner 23 determines that the GPS orientation θ_{GPS} has a low reliability and sets the reliability flag to “OFF”. If the current GPS orientation θ_{GPS1} is within the estimated range, then in Step 106, the GPS reliability determiner 23 determines that the GPS orientation θ_{GPS} has a high reliability and sets the reliability flag to “ON”. Since the estimated range depends on the linearity of the vehicle, the GPS reliability determiner 23 first determines whether the vehicle travels linearly. If the vehicle travels linearly, the GPS reliability determiner 23 sets the estimated range according to Equation (12) and determines whether the GPS orientation θ_{GPS1} is within the estimated range.

Δθ′=|(θ_{GPS1}−(θᵢ₋₁+θ_{gyro})|≦10° (12)

where θᵢ₋₁ denotes the previous travel angle. If the vehicle does not travel linearly, the GPS reliability determiner 23 sets an estimated range according to Δθ′≦14° and determines whether the GPS orientation θ_{GPS1} is within the estimated range.

### Update Process at Startup of Navigation System

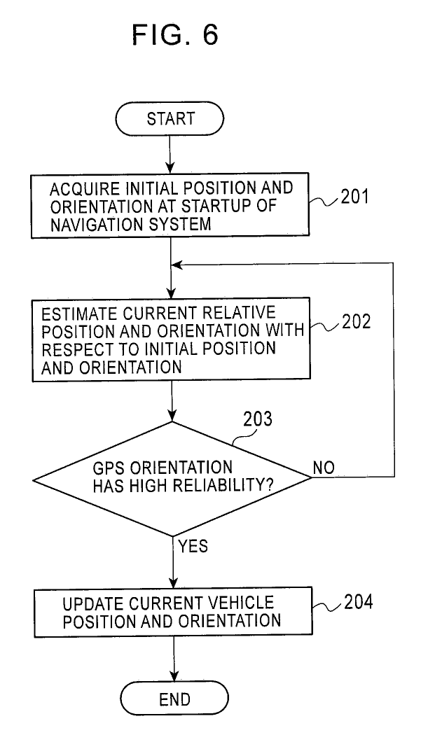

FIG. 6 is a flowchart schematically showing an example of an update process in the vehicle position-and-orientation updating section 16 when the navigation system is made operative.

After the navigation system is turned on to make the navigation system operative, in Step 201, the position-and-orientation estimator 21 acquires the initial vehicle position and orientation stored in the memory MEM. In the example shown in FIG. 1, the initial position and orientation are the vehicle position Pₛ(xₛ,yₛ) and the vehicle orientation θₛ, respectively, when the navigation system is turned off before the turntable TBL is rotated. The initial orientation θₛ is shifted from the actual vehicle orientation by 180° due to the rotation of the turntable.

When the vehicle starts to travel, in Step 202, the position-and-orientation estimator 21 estimates the current vehicle position (x,y) and orientation θ by using the signals output from the dead reckoning sensor 3, the initial vehicle position Pₛ(xₛ,yₛ), and the initial orientation θₛ and outputs the estimated vehicle position (x,y) and orientation θ. In the example shown in FIG. 1, since the initial orientation θₛ is shifted from the actual vehicle orientation by 180°, the trajectory DRT indicated by the solid line is displayed on the monitor 5 in the navigation system even if the vehicle travels along the actual travel trajectory ART indicated by the dotted line.

After the navigation system becomes operative, in Step 203, the GPS reliability determiner 23 determines whether the GPS orientation has a high reliability in accordance with the flowchart shown in FIG. 5 and supplies the monitoring result to the position-and-orientation updater 24. If the GPS orientation has a low reliability, the position-and-orientation updater 24 does not update the position and orientation, and the position-and-orientation estimator 21 estimates the current vehicle position (x,y) and orientation θ by using the signals output from the dead reckoning sensor 3 and outputs the estimated vehicle position (x,y) and orientation θ.

Steps 202 to 203 are subsequently repeated concurrently with the travel of the vehicle. If the reliability of the GPS orientation becomes sufficiently high (the determination in Step 203 is affirmative), then in Step 204, the position-and-orientation updater 24 updates the current vehicle position and orientation by using the GPS orientation θ_{g}, the estimated position (x_{d},y_{d}), and the estimated orientation θ_{d}. Although the current position yielded from the update step may not be on the road, the current vehicle position is updated to a position on the road by the map matching process performed after the update step.

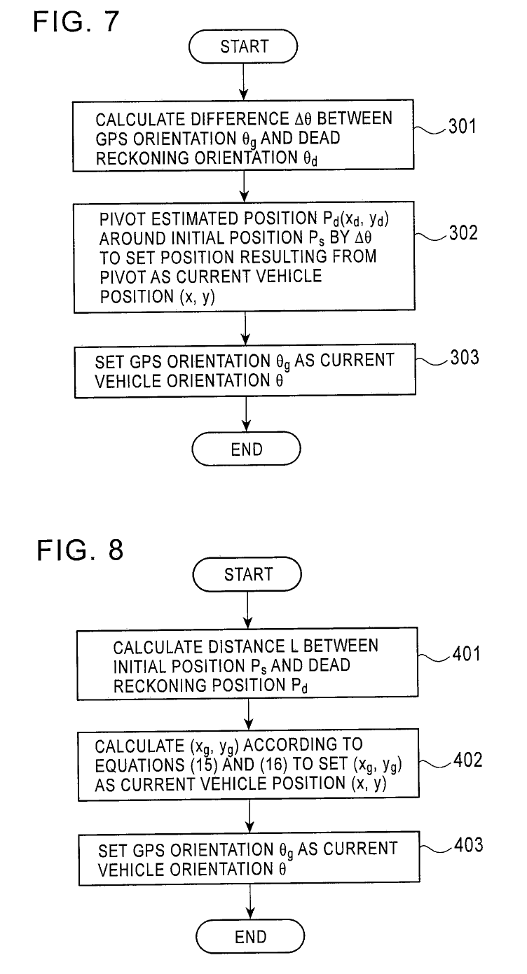

FIG. 7 is a flowchart showing an example of the position and orientation update step in Step 204.

Referring to FIG. 7, in Step 301, the position-and-orientation updater 24 calculates a difference Δθ between the GPS orientation θ_{g} and the estimated orientation θ_{d} when the reliability of the GPS orientation becomes sufficiently high according to Equation (13), as described above with reference to FIGS. 2A and 2B.

Δθ=θ_{d}−θ_{g} (13)

In Step 302, the position-and-orientation updater 24 performs pivot calculation for pivoting the estimated position P_{d}(x_{d},y_{d}) around the initial position Pₛ(xₛ,yₛ) counterclockwise by the difference Δθ and sets the position resulting from the pivot as the new current vehicle position (x,y). In Step 303, the position-and-orientation updater 24 sets the GPS orientation θ_{g} when the reliability of the GPS orientation becomes sufficiently high as the new current vehicle orientation θ. Subsequently, the position-and-orientation estimator 21 estimates the current vehicle position and orientation by dead reckoning navigation by using the updated current position and orientation as the initial position and orientation and by using the signals output from the dead reckoning sensor 3.

FIG. 8 is a flowchart showing another example of the position and orientation update step in Step 204.

Referring to FIG. 8, in Step 401, the position-and-orientation updater 24 calculates a distance L between the initial position Pₛ(xₛ,yₛ) and the estimated position P_{d}(x_{d},y_{d}) (refer to FIG. 2A) according to Equation (14):

L=\sqrt{(x_{d}−xₛ)²+(y_{d}−yₛ)²} (14)

In Step 402, the position-and-orientation updater 24 calculates the coordinate (x_{g},y_{g}) of a position P_{g} spaced apart from the initial position Pₛ(xₛ,yₛ) in the direction of the GPS orientation θ_{g} by the distance L and sets the position P_{g} as the current vehicle position (x,y). Specifically, the position-and-orientation updater 24 calculates the position P_{g} (x_{g},y_{g}) according to Equations (15) and (16) and sets the P_{g}(x_{g},y_{g}) as the current vehicle position (x,y).

x_{g}=xₛ+L·cos θ_{g} (15)

y_{g}=yₛ+L·sin θ_{g} (16)

In Step 403, the position-and-orientation updater 24 sets the GPS orientation θ_{g} when the reliability of the GPS orientation becomes sufficiently high as the new current vehicle orientation θ. Subsequently, the position-and-orientation estimator 21 estimates the current vehicle position and orientation by dead reckoning navigation by using the updated current position and orientation as the initial position and orientation and by using the signals output from the dead reckoning sensor 3.

Although the case in which the initial orientation stored in the navigation system is shifted from the actual orientation due to the rotation of the turntable is described, the present invention is not limited to the above case. The embodiments of the present invention are applicable to cases in which the navigation system becomes operative. Particularly, the embodiments of the present invention are effective, for example, when the navigation system is made operative after the vehicle is parked in a multi-level parking garage that is not capable of GPS reception and the vehicle leaves the multi-level parking garage.

### Advantages

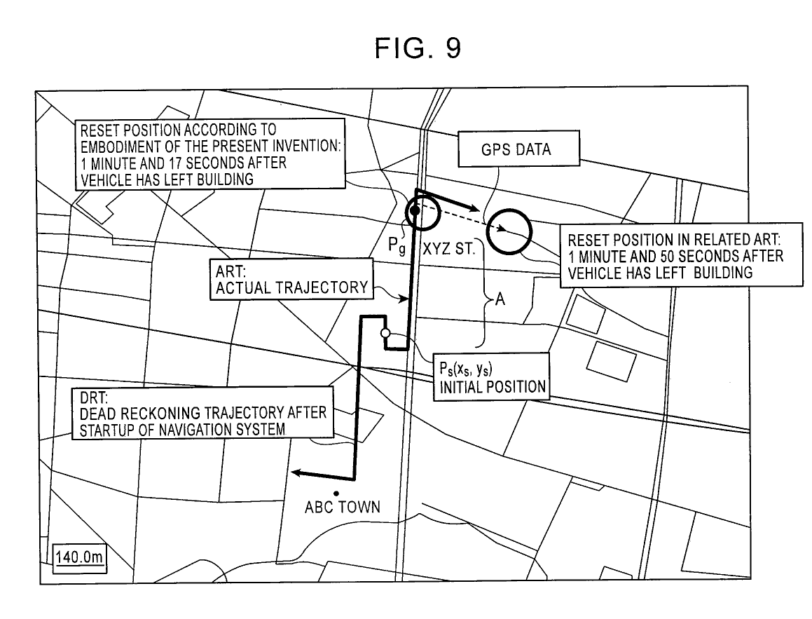

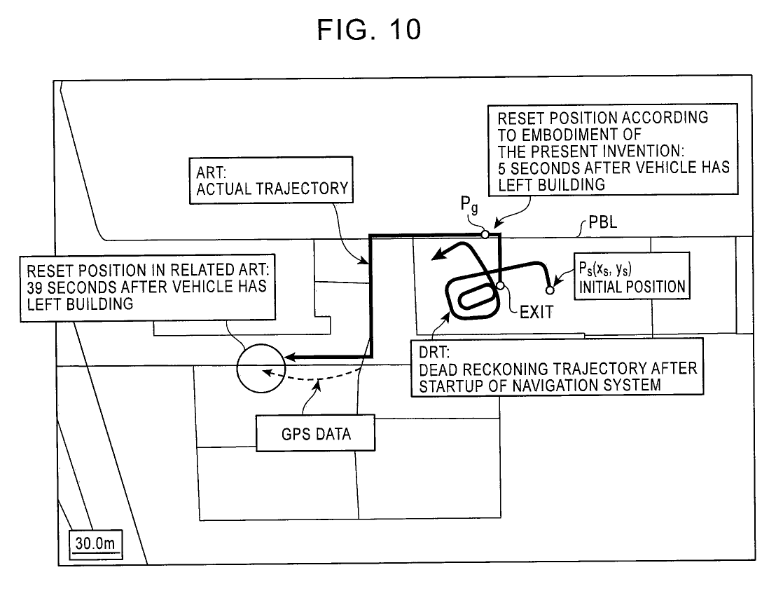

FIG. 9 illustrates a first exemplary advantage of the present invention. FIG. 9 shows a position (reset position) where the position estimated by dead reckoning navigation indicates the correct current vehicle position in the case in which the navigation system mounted in a vehicle is turned off after the vehicle gets on a turntable, the vehicle is rotated by the turntable by 180°, and the vehicle starts to travel with the navigation system operative. For comparison, a reset position in the related art is also shown in FIG. 9. In the example shown in FIG. 9, the three-dimensional positioning by the GPS is disabled during a travel zone A (corresponding to a travel time of 1 minute and 12 seconds).

According to the present invention, the reliability of the GPS orientation becomes sufficiently high and the update of the current vehicle position is performed at a point P_{g} five seconds after the three-dimensional positioning becomes enabled, that is, 1 minute and 17 seconds after the vehicle starts to travel. As a result, the estimated position P_{d}(x_{d},y_{d}) comes to indicate the coordinate (x,y) of the correct current vehicle position. However, since the current vehicle position is updated after the reliabilities of both the GPS position and the GPS orientation become sufficiently high in the related art, the current vehicle position is updated 38 seconds after the three-dimensional positioning becomes enabled, that is, 1 minute and 50 seconds after the vehicle starts to travel, and the estimated position P_{d}(x_{d},y_{d}) comes to indicate the correct current vehicle position (x,y).

As shown in FIG. 9, according to the present invention, it is possible to display the vehicle position mark and/or the travel trajectory at the correct positions on the map in a shorter time, compared with the related art, after the three-dimensional positioning becomes enabled or after the vehicle starts to travel even if the vehicle orientation recognized by the navigation system is shifted from the actual vehicle orientation due to the rotation of the turntable.

FIG. 10 illustrates a second exemplary advantage of the present invention. FIG. 10 shows a reset position in the case in which a vehicle is parked in a multi-level parking garage that is not capable of GPS reception and the vehicle leaves the parking garage with the navigation system in the vehicle operative. For comparison, a reset position in the related art is also shown in FIG. 10. In the example shown in FIG. 10, “PBL” denotes a multi-level parking garage, “EXIT” denotes an exit of the multi-level parking garage, “Ps” denotes the position where the vehicle is parked in the multi-level parking garage (the initial position), “DRT” denotes a dead reckoning navigation trajectory after the navigation system becomes operative, and “ART” denotes the actual travel trajectory.

According to the present invention, the reliability of the GPS orientation becomes sufficiently high and the update of the current vehicle position is performed at a point P_{g} five seconds after the vehicle leaves the multi-level parking garage and the three-dimensional positioning becomes enabled. As a result, the estimated position P_{d}(x_{d},y_{d}) comes to indicate the coordinate (x,y) of the correct current vehicle position. However, since the current vehicle position is updated after the reliabilities of both the GPS position and the GPS orientation become sufficiently high in the related art, the current vehicle position is updated 39 seconds after the three-dimensional positioning becomes enabled, and the estimated position P_{d}(x_{d},y_{d}) comes to indicate the correct current vehicle position (x,y).

As shown in FIG. 10, according to the present invention, it is possible to display the vehicle position mark and/or the travel trajectory at the correct positions on the map in a shorter time, compared with the related art, after the three-dimensional positioning becomes enabled or after the vehicle starts to travel even if the vehicle orientation recognized by the navigation system is shifted from the actual vehicle orientation because the vehicle traveled in the multi-level parking garage.

### Second Embodiment

There is a case in which a vehicle enters a multi-level parking garage and leaves the multi-level parking garage without turning off the navigation system in the vehicle. This corresponds to a case in which the multi-level parking garage has no free space. In such a case, after entering the multi-level parking garage, the vehicle repeats circular movement while ascending or descending the slope in the multi-level parking garage to leave the parking garage. Since the vehicle performs the circular movement while tilting toward one side in the multi-level parking garage, the difference in the gyro sensitivity is increased and the actual vehicle orientation is shifted from the estimated orientation when the vehicle leaves the multi-level parking garage.

Accordingly, in the second embodiment of the present invention, the entry of the vehicle in the multi-level parking garage is detected, the estimated position and orientation at the detection are stored as the initial position and orientation in the first embodiment, and control similar to the first embodiment is performed.

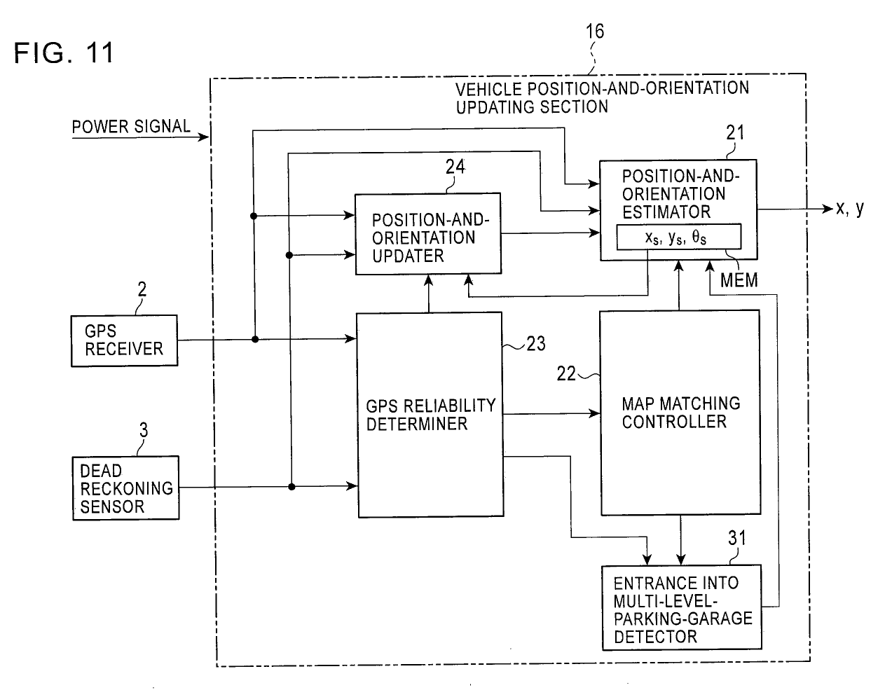

FIG. 11 is a block diagram showing an example of the configuration of a vehicle position-and-orientation updating section 16 according to the second embodiment of the present invention. The same reference numerals are used in FIG. 11 to identify the same components shown in FIG. 4 in the first embodiment of the present invention. The vehicle position-and-orientation updating section 16 shown in FIG. 11 differs from the vehicle position-and-orientation updating section 16 shown in FIG. 4 in that the vehicle position-and-orientation updating section 16 in FIG. 11 includes an entrance into multi-level parking garage detector 31. The entrance into multi-level parking garage detector 31 detects that the vehicle enters the multi-level parking garage when the three-dimensional positioning by the GPS is disabled and map matching is also disabled.

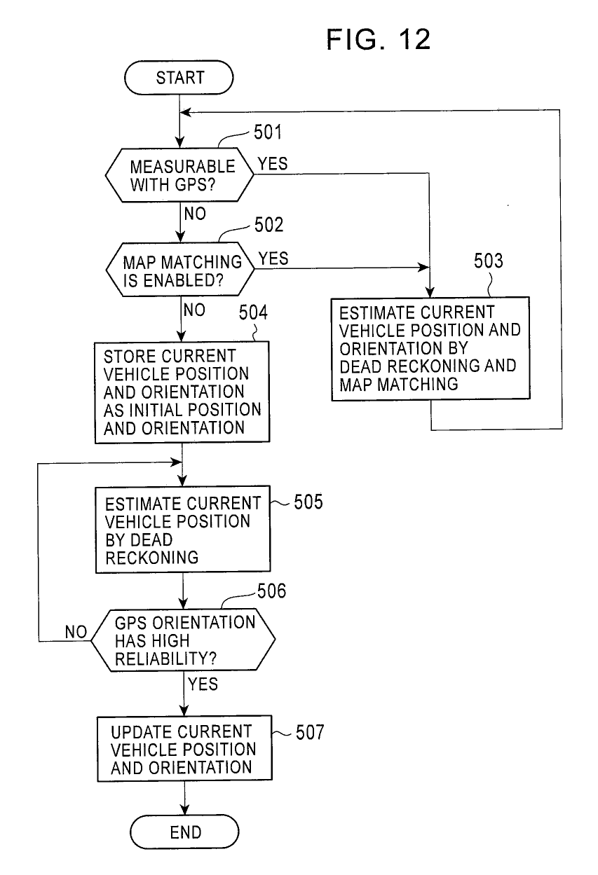

FIG. 12 is a flowchart showing an example of an update process in the vehicle position-and-orientation updating section 16 according to the second embodiment of the present invention.

In Steps 501 and 502, the entrance into multi-level parking garage detector 31 in the vehicle position-and-orientation updating section 16 determines that the vehicle enters the multi-level parking garage if the three-dimensional positioning by the GPS is disabled and map matching is also disabled. The disablement of map matching is included in the conditions for the entry of the vehicle into the multi-level parking garage in order to distinguish the entry of the vehicle into the multi-level parking garage from the entry of the vehicle into a tunnel.

If the vehicle does not enter the multi-level parking garage, then in Step 503, the position-and-orientation estimator 21 continues to estimate the current vehicle position and orientation on the basis of dead reckoning navigation and map matching. In contrast, if the entry of the vehicle into the multi-level parking garage is detected because the three-dimensional positioning by the GPS is disabled and map matching is also disabled, then in Step 504, the position-and-orientation estimator 21 stores the current vehicle position and orientation as the initial position (xₛ,yₛ) and the initial orientation θₛ.

In Step 505, the position-and-orientation estimator 21 estimates the current vehicle position (x,y) and orientation θ by using the signals output from the dead reckoning sensor 3, the initial vehicle position (xₛ,yₛ) and the initial orientation θₛ. After the vehicle enters the multi-level parking garage, in Step 506, the GPS reliability determiner 23 monitors the reliability of the GPS orientation in accordance with the determination process shown in FIG. 5 and supplies the monitoring result to the position-and-orientation updater 24. If the GPS orientation has a low reliability, the position-and-orientation updater 24 does not update the position and orientation and the position-and-orientation estimator 21 estimates the current vehicle position (x,y) and orientation θ by using the signals output from the dead reckoning sensor 3.

Steps 505 to 506 are subsequently repeated concurrently with the travel of the vehicle. If the vehicle leaves the multi-level parking garage and the reliability of the GPS orientation becomes sufficiently high (the determination in Step 506 is affirmative), then in Step 507, the position-and-orientation updater 24 updates the current vehicle position and orientation by using the GPS orientation θ_{g}, the estimated position (x_{d},y_{d}), and the estimated orientation θ_{d}. The current vehicle position and orientation are updated in Step 507 in the same manner as in the first embodiment (refer to FIGS. 7 and 8).

Although the current position yielded from the update step in Step 507 may not be on a road, the current vehicle position is updated to a position on the road by the map matching process performed after the update step.

According to the second embodiment of the present invention, it is possible to update the vehicle position and orientation to the correct position and orientation within a short time when the vehicle leaves the multi-level parking garage without stopping the control of the navigation system in the multi-level parking garage.

### Exemplary Modification

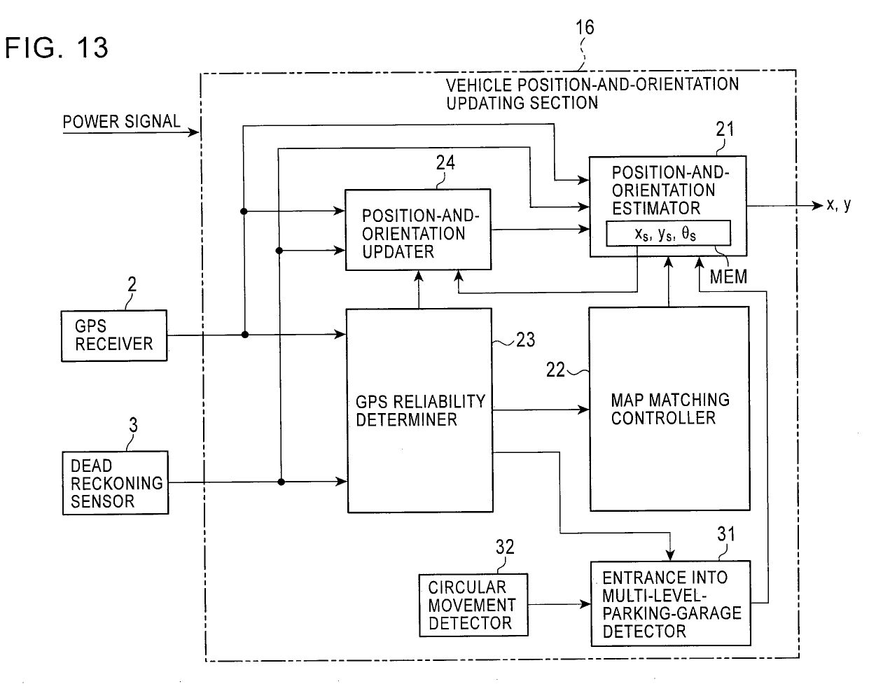

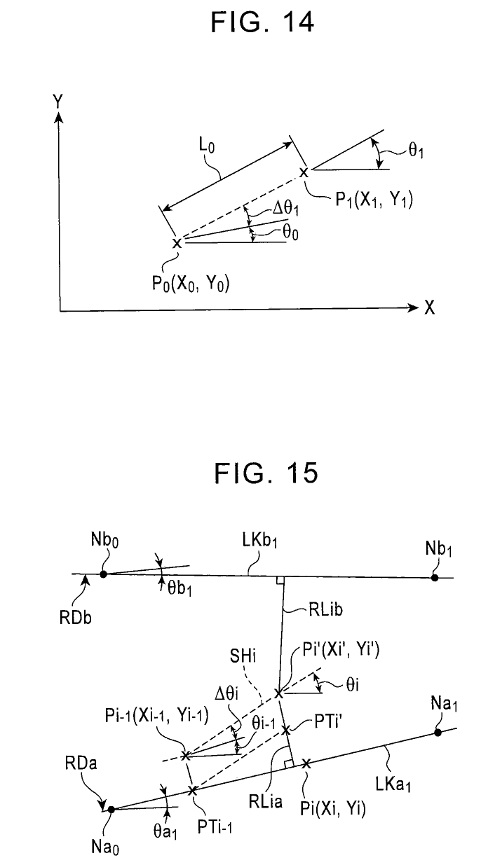

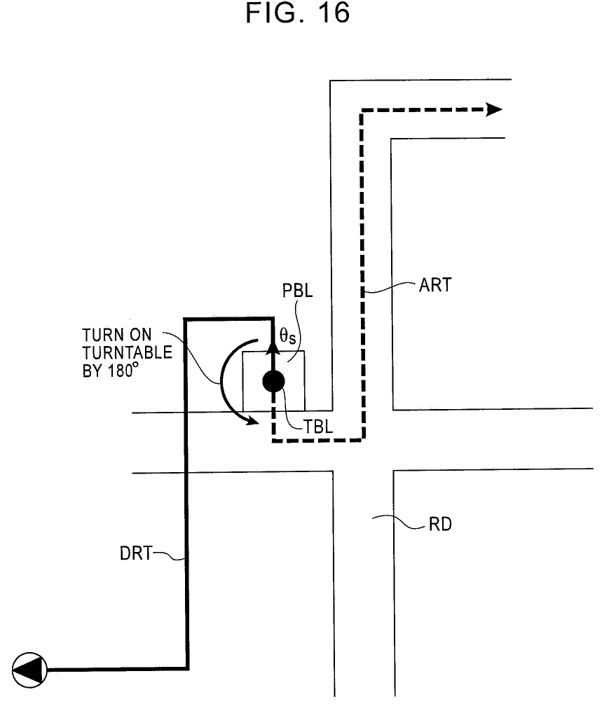

Although it is determined in the second embodiment that the vehicle enters the multi-level parking garage if the three-dimensional positioning by the GPS is disabled and map matching is also disabled, it may be determined that the vehicle enters the multi-level parking garage if the three-dimensional positioning by the GPS is disabled and the vehicle repeats the circular movement during a predetermined time period. FIG. 13 is a block diagram showing an example of the configuration of a vehicle position-and-orientation updating section 16 when the entry of the vehicle into the multi-level parking garage is detected in the above situation. The same reference numerals are used in FIG. 13 to identify the same components shown in FIG. 11 in the second embodiment of the present invention. The vehicle position-and-orientation updating section 16 in FIG. 13 differs from the vehicle position-and-orientation updating section 16 in FIG. 11 in that the vehicle position-and-orientation updating section 16 in FIG. 13 includes a circular movement detector 32. The entrance into multi-level parking garage detector 31 detects that the vehicle enters the multi-level parking garage if the three-dimensional positioning by the GPS is disabled and the vehicle repeats the circular movement during a predetermined time period.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A method of updating the position and orientation of a vehicle at startup of a navigation system using both a GPS receiver and a dead reckoning sensor, the method comprising:
storing the vehicle position and orientation when the navigation system is inoperative and setting the stored vehicle position and orientation as the initial vehicle position and orientation when the navigation system is operative;
estimating a vehicle position and orientation by using a signal output from the dead reckoning sensor and the initial vehicle position and orientation after the navigation system becomes operative;
determining whether the reliability of a GPS orientation obtained by the GPS receiver becomes sufficiently high after the navigation system becomes operative; and
updating the current vehicle position by using the GPS orientation and the estimated vehicle position when the reliability of the GPS orientation obtained by the GPS receiver becomes sufficiently high.

2. The method of updating the position and orientation of a vehicle according to claim 1,
wherein the GPS orientation is set as the current vehicle orientation when the reliability of the GPS orientation becomes sufficiently high.

3. The method of updating the position and orientation of a vehicle according to claim 1,
wherein the determining act determines that the reliability of the GPS orientation becomes sufficiently high when the GPS receiver performs three-dimensional positioning, the vehicle travel speed is not lower than a predetermined value, the ratio between the travel distance calculated by the dead reckoning sensor and the travel distance calculated with the GPS position is not higher than a predetermined value, and the difference between the orientation of the straight line between two GPS positions and the GPS orientation is not higher than a predetermined value.

4. The method of updating the position and orientation of a vehicle according to claim 1,
wherein the updating act calculates a difference Δθ between the GPS orientation and the estimated vehicle orientation and sets the vehicle position obtained by pivoting the estimated vehicle position around the initial vehicle position by the difference Δθ as the current vehicle position.

5. The method of updating the position and orientation of a vehicle according to claim 1,
wherein the updating act calculates a distance between the initial vehicle position and the estimated vehicle position and sets the position spaced apart from the initial vehicle position in the direction of the GPS orientation by the calculated distance as the current vehicle position.

6. An apparatus for updating the position and orientation of a vehicle at startup of a navigation system using both a GPS receiver and a dead reckoning sensor, the apparatus comprising:
a storage unit that stores the vehicle position and orientation when the navigation system is inoperative as the initial vehicle position and orientation when the navigation system becomes operative;
a position-and-orientation estimating unit that estimates a vehicle position and orientation by using a signal output from the dead reckoning sensor and the initial vehicle position and orientation after the navigation system becomes operative;
a GPS orientation reliability determining unit that determines whether the reliability of a GPS orientation obtained by the GPS receiver becomes sufficiently high after the navigation system becomes operative; and
an updating unit that updates the current vehicle position by using the GPS orientation and the estimated vehicle position when the reliability of the GPS orientation obtained by the GPS receiver becomes sufficiently high.

7. The apparatus for updating the position and orientation of a vehicle according to claim 6,
wherein the updating unit sets the GPS orientation as the current vehicle orientation when the reliability of the GPS orientation becomes sufficiently high.

8. The apparatus for updating the position and orientation of a vehicle according to claim 6,
wherein the GPS orientation reliability determining unit determines that the reliability of the GPS orientation becomes sufficiently high when the GPS receiver performs three-dimensional positioning, the vehicle travel speed is not lower than a predetermined value, the ratio between the travel distance calculated by the dead reckoning sensor and the travel distance calculated with the GPS position is not higher than a predetermined value, and the difference between the orientation of the straight line between two GPS positions and the GPS orientation is not higher than a predetermined value.

9. The apparatus for updating the position and orientation of a vehicle according to claim 6,
wherein the updating unit includes calculating means for calculating a difference Δθ between the GPS orientation and the estimated vehicle orientation and updating means for updating the current vehicle position by pivoting the estimated vehicle position around the initial vehicle position by the difference Δθ.

10. The apparatus for updating the position and orientation of a vehicle according to claim 6,
wherein the updating unit includes calculating means for calculating a distance between the initial vehicle position and the estimated vehicle position and means for setting the position spaced apart from the initial vehicle position in the direction of the GPS orientation by the calculated distance as the current vehicle position.

11. A method of updating the position and orientation of a vehicle at startup of a navigation system using both a GPS receiver and a dead reckoning sensor, the method comprising:
storing the vehicle position and orientation at a time when entry of the vehicle into a multi-level parking garage is detected;
estimating a current vehicle position and orientation by using a signal output from the dead reckoning sensor and the stored vehicle position and orientation after the entry of the vehicle into the multi-level parking garage is detected;
determining whether the reliability of a GPS orientation obtained by the GPS receiver becomes sufficiently high after the entry of the vehicle into the multi-level parking garage is detected; and
updating the current vehicle position by using the GPS orientation and the estimated vehicle position when the reliability of the GPS orientation obtained by the GPS receiver becomes sufficiently high.

12. The method of updating the position and orientation of a vehicle according to claim 11,
wherein it is determined that the vehicle enters the multi-level parking garage when no GPS signal is received and map matching is disabled.

13. The method of updating the position and orientation of a vehicle according to claim 11,
wherein it is determined that the vehicle enters the multi-level parking garage when no GPS signal is received and the vehicle repeats circular movement.

14. The method of updating the position and orientation of a vehicle according to claim 11,
wherein the GPS orientation is set as the current vehicle orientation when the reliability of the GPS orientation becomes sufficiently high.

15. The method of updating the position and orientation of a vehicle according to claim 11,
wherein the updating act calculates a difference Δθ between the GPS orientation and the estimated vehicle orientation and sets the vehicle position obtained by pivoting the estimated vehicle position around the stored vehicle position by the difference Δθ as the current vehicle position.

16. The method of updating the position and orientation of a vehicle according to claim 11,
wherein the updating act calculates a distance between the stored vehicle position and the estimated vehicle position and sets the position spaced apart from the stored vehicle position in the direction of the GPS orientation by the calculated distance as the current vehicle position.

17. An apparatus for updating the position and orientation of a vehicle at startup of a navigation system using both a GPS receiver and a dead reckoning sensor, the apparatus comprising:
a detecting unit that detects entry of the vehicle into a multi-level parking garage;
a storage unit that stores the vehicle position and orientation when the entry of the vehicle into the multi-level parking garage is detected;
a position-and-orientation estimating unit that estimates a current vehicle position and orientation by using a signal output from the dead reckoning sensor and the stored vehicle position and orientation after the entry of the vehicle into the multi-level parking garage is detected;
a GPS orientation reliability determining unit that determines whether the reliability of a GPS orientation obtained by the GPS receiver becomes sufficiently high after the entry of the vehicle into the multi-level parking garage is detected; and
an updating unit that updates the current vehicle position by using the GPS orientation and the estimated vehicle position when the reliability of the GPS orientation obtained by the GPS receiver becomes sufficiently high.

18. The apparatus for updating the position and orientation of a vehicle according to claim 17,
wherein the updating unit sets the GPS orientation as the current vehicle orientation when the reliability of the GPS orientation becomes sufficiently high.

19. The apparatus for updating the position and orientation of a vehicle according to claim 17,
wherein the updating unit includes calculating means for calculating a difference Δθ between the GPS orientation and the estimated vehicle orientation and updating means for updating the current vehicle position by pivoting the estimated vehicle position around the stored vehicle position by the difference Δθ.

20. The apparatus for updating the position and orientation of a vehicle according to claim 17,
wherein the updating unit includes calculating means for calculating a distance between the stored vehicle position and the estimated vehicle position and means for setting the position spaced apart from the stored vehicle position in the direction of the GPS orientation by the calculated distance as the current vehicle position.
